(19) United States
(12) Patent Application Publication
(10) Pub. No.: US 2025/0077557 A1
(43) Pub. Date: Mar. 6, 2025

(54) SYSTEMS AND METHODS FOR NEURODIVERGENCE-DRIVEN AMBIGUITY DETECTION AND RESOLUTION

(71) Applicant: JPMORGAN CHASE BANK, N.A., New York, NY (US)

(72) Inventor: Henry DEARDS, Poole (GB)

(21) Appl. No.: 18/459,298

(22) Filed: Aug. 31, 2023

(51) Int. Cl. G06F 16/33; G06F 16/35

(52) U.S. Cl. CPC G06F 16/3344; G06F 16/3334; G06F 16/35

(57) ABSTRACT

Systems and methods for neurodivergence-driven ambiguity detection and resolution are disclosed. In one embodiment, a method for neurodivergence-driven ambiguity detection and resolution may include: (1) receiving, by an ambiguity detection training computer program executed by an electronic device, a labeled dataset comprising data labeled by one or more neurodivergent individuals, wherein the data is labeled as clear or ambiguous; (2) training, by the ambiguity detection training computer program, an ambiguity detection engine using the labeled dataset to predict ambiguities in new data; and (3) deploying, by the ambiguity detection training computer program, the ambiguity detection engine to a computer program or system, wherein the ambiguity detection engine is configured to receive the new data, predict whether the new data is ambiguous, and present a modification to the new data based on the prediction.

### BACKGROUND OF THE INVENTION

### 1. Field of the Invention

Embodiments relate to systems and methods for neurodivergence-driven ambiguity detection and resolution.

### 2. Description of the Related Art

Large organizations often have offices and staff across many continents who serve vital interconnected business functions. This necessitates vast quantities of globe-spanning communication between people who may not share a first language. Unfortunately, internal documentation can be confusing, unclear or inadequate. This often leads to direct communication between teams and all the associated delays common to an extended email conversation which would be rendered entirely unnecessary by clearer, easier to comprehend data. These problems can be exacerbated when the communication involves people whose native language is not the one being used to communicate.

### SUMMARY OF THE INVENTION

Systems and methods for neurodivergence-driven ambiguity detection and resolution are disclosed. In one embodiment, a method for neurodivergence-driven ambiguity detection and resolution may include: (1) receiving, by an ambiguity detection training computer program executed by an electronic device, a labeled dataset comprising data labeled by one or more neurodivergent individuals, wherein the data is labeled as clear or ambiguous; (2) training, by the ambiguity detection training computer program, an ambiguity detection engine using the labeled dataset to predict ambiguities in new data; and (3) deploying, by the ambiguity detection training computer program, the ambiguity detection engine to a computer program or system, wherein the ambiguity detection engine is configured to receive the new data, predict whether the new data is ambiguous, and present a modification to the new data based on the prediction.

In one embodiment, the data may include text or graphics.

In one embodiment, the data may be labeled on a scale.

In one embodiment, the data may be labeled with a replacement.

In one embodiment, the ambiguity detection engine may be trained using supervised learning.

In one embodiment, the method may also include verifying, by the ambiguity detection training computer program, the ambiguity detection engine before it is deployed.

In one embodiment, the ambiguity detection engine may be a plug-in to a computer program, and the computer program may include a word processing program, a coding program, an email program, and/or a messaging program.

In one embodiment, the ambiguity detection engine may be available via an application programming interface (“Application Programming Interface” or “API”).

In one embodiment, the ambiguity detection engine may be configured to scan a code repository and/or a document repository.

In one embodiment, the method may also include: receiving, by the ambiguity detection engine, feedback on the modification; and re-training, by the ambiguity detection training computer program, the ambiguity detection engine based on the feedback.

In one embodiment, the training results in a plurality of mutually non-dominating models.

In one embodiment, the ambiguity detection engine may be configured to select a detection level and to select one of the mutually non-dominating models based on the selection.

In one embodiment, each of the mutually non-dominating models has a different inclination to produce both true positive results and false positive results.

According to another embodiment, a system may include: an electronic device executing an ambiguity detection training computer program; a labeled dataset comprising data labeled by one or more neurodivergent individuals, wherein the data is labeled as clear or ambiguous; and a user electronic device executing a computer program. The ambiguity detection training computer program receives the labeled dataset; and trains an ambiguity detection engine using the labeled dataset to predict ambiguities in new data; deploys the ambiguity detection engine to the computer program. The computer program receives the new data; predicts, using the ambiguity detection engine, whether the new data is ambiguous; and presents a modification to the new data based on the prediction.

In one embodiment, the ambiguity detection engine may be deployed as a plug-in to a computer program, and the computer program may include a word processing program, a coding program, an email program, and/or a messaging program.

In one embodiment, the ambiguity detection engine may be deployed as an Application Programming Interface.

In one embodiment, the new data may include data in a code repository and/or a document repository.

In one embodiment, the ambiguity detection engine receives feedback on the modification and re-trains the ambiguity detection engine based on the feedback.

In one embodiment, the training results in a plurality of mutually non-dominating models, wherein each of the mutually non-dominating models has a different inclination to produce both true positive results and false positive results.

In one embodiment, the ambiguity detection engine may be configured to select a detection level and to select one of the mutually non-dominating models based on the selection.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for neurodivergence-driven ambiguity detection and resolution according to an embodiment;

FIG. 2 depicts a method for neurodivergence-driven ambiguity detection and resolution according to an embodiment;

FIG. 3 depicts an exemplary computing system for implementing aspects of the present disclosure.

### DETAILED DESCRIPTION OF PREFERRED EMBODIMENTS

Systems and methods for neurodivergence-driven ambiguity detection and resolution are disclosed.

Neurodiverse individuals, such as individuals on the autism spectrum, have unique insights and patterns of thought which provide different perspectives than their neurotypical counterparts. One of the most prominent areas of this comparative advantage is in the detection of unclear or ambiguous data. Neurodivergent individuals are exceptional at detecting unclear or ambiguous data, primarily due to the difficulties that they often have in understanding such data.

Embodiments may provide an artificially intelligent system that may be trained using data labelled by neurodivergent individuals to detect and suggest resolutions for ambiguities in data. For example, embodiments may provide a programmatic tool based on this labeling to detect ambiguous data across a variety of formats (e.g., text, graphics, user interfaces, etc.) and provide suggestions on how to resolve ambiguities.

In embodiments, the programmatic tool may be integrated with code scanning tools, email programs, document collaboration programs, etc. to proactively engage with individuals as they are producing data by, for example, highlighting potential ambiguities and suggesting ways to resolve those ambiguities. This improves the quality and clarity of documentation, emails, and user interfaces, making them more accessible to neurodivergent employees as well as multi-lingual employees that communicate in a non-native language to better collaborate with teams from other cultures.

Examples of documents and interfaces may include program code, code comments for internal documentation, README files for applications, external documentation on the use of applications, user interfaces, graphs and metrics that track various key performance indicators, business flow diagrams, documents that aid in the execution of more manual business processes, etc.

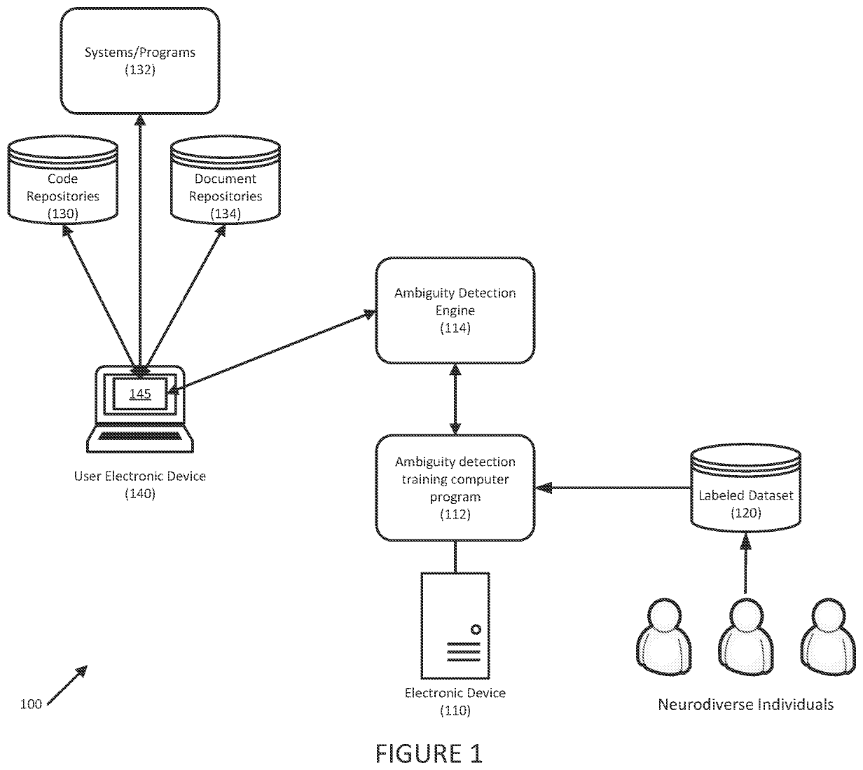

Referring to FIG. 1, a system for neurodivergence-driven ambiguity detection and resolution is disclosed according to one embodiment. System 100 may include electronic device 110 that may execute ambiguity detection training computer program 112. Ambiguity detection training computer program 112 may use data that is labeled by neurodiverse individuals using electronic devices (not shown) in labeled dataset 120 to train ambiguity detection engine 114. For example, the data in labeled dataset 120 may be labeled by the neurodiverse individuals to identify the data as clear, ambiguous/unclear, etc. The labeling may be binary, or it may have a scale (e.g., 1-5, with 1 being clear and 5 being ambiguous/unclear). Any suitable labeling convention may be used as is necessary and/or desired.

In one embodiment, the data may be of any suitable type that for which initial examples can be sourced for training. Examples may include text, graphics, etc., and may be related to process flows, program code, other structured data, domain-specific languages, specialized data representations for business areas/problems that require a higher level of abstraction, etc.

Once trained, ambiguity detection training computer program 112 may deploy ambiguity detection engine 114 to program 145 executed by user electronic device 140, such as coding programs, word processing programs, email programs, messaging programs, document collaboration programs, web design programs, graphical design programs, etc. In one embodiment, ambiguity detection engine 114 may be deployed as a plug-in or extension to program 145, may be accessible to program 145 via application programming interface (API), etc.

In one embodiment, a user may use program 145 to access code in code repositories 130, systems/programs 132 (e.g., email systems), document repositories 134, etc. The deployed ambiguity detection engine 114 may analyze data, may detect ambiguities in the data, and may make recommendations on how to resolve the ambiguities.

In one embodiment, ambiguity detection engine 114 may receive feedback on the quality of suggested amendments to ambiguous data, and the feedback may be used to retrain the ambiguity detection engine 114. This will allow feedback from live users to help the model suggest the best possible resolution to ambiguity and improve over time as it is used.

Embodiments may further use multifactor optimization to simultaneously optimize ambiguity detection engine 114 to maximize true positive results and minimize false positive results. Such optimization may produce a population of models that may be used by ambiguity detection engine 114 that are all mutually non-dominating, known as the pareto front. None of these models would be superior to any of the others on both of the features being optimized, but the range of models would produce a spread in how “aggressive” (i.e., inclined to produce both a true positive and false positive result) ambiguity detection engine 114 is. The wider population of models may be iteratively improved with, for example, reinforcement learning from active users, which may result in more sophisticated and tailored models through wider variety and mutation. The models may also be used to tailor the experience of each user to a model that best suits the user's needs. For example, users who are more likely to miss ambiguity and respond well to prompts may be given more aggressive models, and vice-versa.

For example, when a model that has been iteratively improved through reinforcement learning driven by feedback from users to the point that it dominates (i.e., it is superior on both of the optimized features) one or more of the other solutions in the pareto front population, those models can be removed from the population and/or retrained with new data gathered from users to bring them back up to the level of the updated pareto front. This allows the models to continue evolving while still providing the users with a customized experience based on explicit feedback, such as by asking the users how much engagement from the tool they want, and implicit feedback, such as monitoring how they respond to notifications of ambiguity from ambiguity detection engine 114.

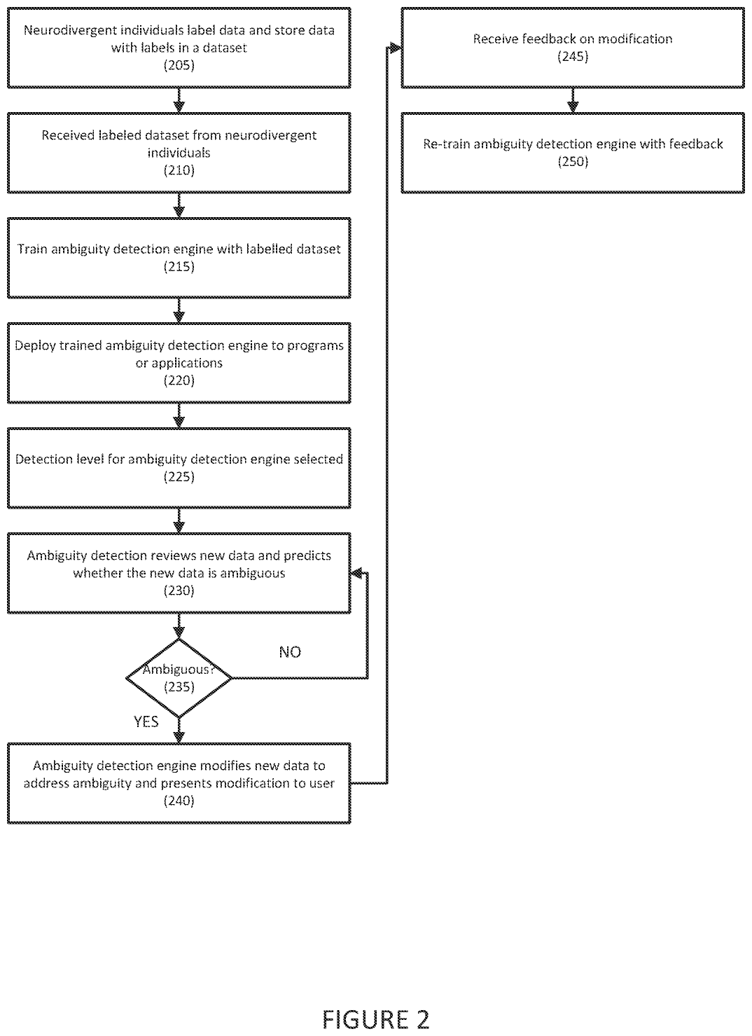

Referring to FIG. 2, a method for neurodivergence-driven ambiguity detection and resolution is disclosed according to an embodiment.

In step 205, one or more neurodivergent individuals label data, and the labeled data may be stored in a dataset. The data may include, for example, code, text data, graphics data, process flows, etc. For example, the neurodivergent individuals may label historic data for an organization, current data for the organization, data outside the organization, etc. using electronic devices.

The neurodivergent individual(s) may label the data as clear or unclear, or may label the data on a scale (e.g., 1-5). In one embodiment, the neurodivergent individual(s) may identify replacements or unclear data.

In step 210, an ambiguity detection training computer program may receive the labeled data in the dataset, and in step 215, may train an ambiguity detection learning engine with the labelled data. Any suitable training protocol may be used, including supervised training, semi-supervised training, etc.

In one embodiment, the ambiguity detection training computer program may train a plurality of models for the ambiguity detection engine to maximize true positive results and minimize false positive results. Such optimization may produce a population of models that may be used by ambiguity detection engine that are all mutually non-dominating. In one embodiment, each model may have a different detection level, such as a level of aggressiveness, or inclination to produce both true positive results and false positive results.

In one embodiment, once the ambiguity detection engine is trained, the ambiguity detection engine may be verified. For example, data that was not used for training may be used to verify that the ambiguity detection engine correctly predicts whether the data is clear or unclear.

In step 220, the trained ambiguity detection engine may be deployed to programs or applications. For example, the ambiguity detection engine may be a plug-in as to a program, may be integrated into a program, may be available via an API, etc.

In step 225, a detection level, such as a level of aggressiveness, may be selected for the ambiguity detection engine. For example, the user may select a detection level, wherein the ambiguity detection engine may be inclined to produce both a true positive and false positive result. In one embodiment, the user may select the detection level by number (e.g., 1-5), by description (aggressive, standard, non-aggressive), etc. In another embodiment, the detection level may be selected for the user based on historical usage of the ambiguity detection engine. For example, an aggressive model may be selected for a user that responds to notifications of ambiguity from ambiguity detection engine.

The ambiguity detection engine may select one of the trained models that corresponds to detection level.

In step 230, the ambiguity detection engine may review data as it is entered or reviewed, and may predict whether the data is ambiguous. In another embodiment, the ambiguity detection engine may scan code repositories and identify ambiguous code, documents, etc. In another embodiment, the ambiguity detection engine may monitor a user's interaction with a process flow and may predict whether the process flow is ambiguous. In still another embodiment, the ambiguity detection engine may receive an incoming document, message, etc., and may predict whether document or message is ambiguous.

In step 235, if the data is ambiguous, in step 240, the ambiguity detection engine may make a recommendation as to how the make the data less ambiguous. For example, the ambiguity detection engine may identify a reason for the ambiguity and may provide the reason to a user.

As another example, if the ambiguity detection engine identifies an ambiguity in an incoming message or document, in step 240, the ambiguity detection engine may modify the document to address the ambiguity before communicating the corrected message or document to the end user. The ambiguity detection engine may identify the modification to the end user.

In step 245, the ambiguity detection engine may receive feedback on the modification. For example, the feedback may be express (e.g., similar to accepting or rejecting a change in a document), or it may be implicit (e.g., types over the change, does not follow the recommendation etc.). In step 250, the ambiguity detection training engine may re-train the ambiguity detection engine based on the feedback.

If the data is not ambiguous, the process may return to step 230.

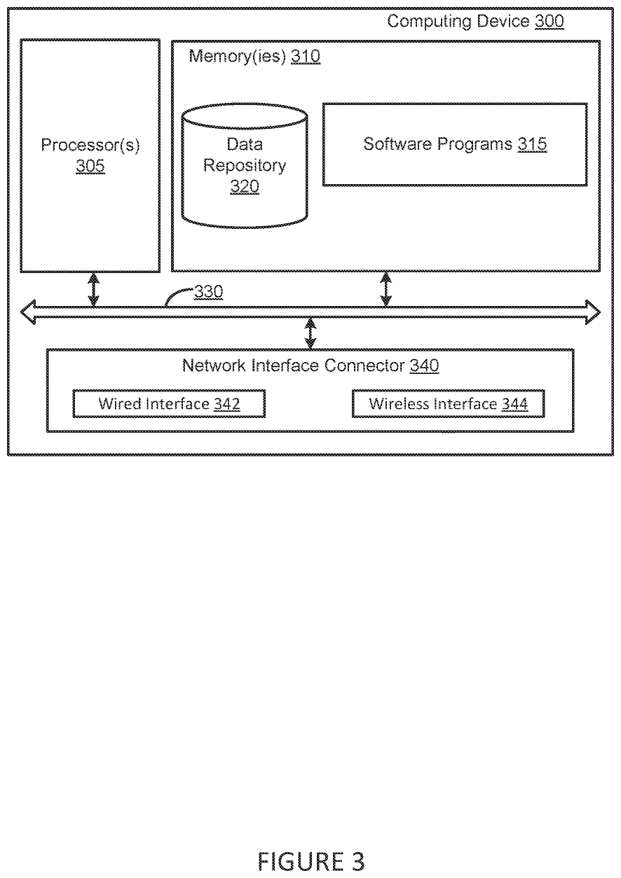

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for neurodivergence-driven ambiguity detection and resolution, comprising:
receiving, by an ambiguity detection training computer program executed by an electronic device, a labeled dataset comprising data labeled by one or more neurodivergent individuals, wherein the data is labeled as clear or ambiguous;
training, by the ambiguity detection training computer program, an ambiguity detection engine using the labeled dataset to predict ambiguities in new data; and
deploying, by the ambiguity detection training computer program, the ambiguity detection engine to a computer program or system, wherein the ambiguity detection engine is configured to receive the new data, predict whether the new data is ambiguous, and present a modification to the new data based on the prediction.

2. The method of claim 1, wherein the data comprises text or graphics.

3. The method of claim 1, wherein the data is labeled on a scale.

4. The method of claim 1, wherein the data is labeled with a replacement.

5. The method of claim 1, wherein the ambiguity detection engine is trained using supervised learning.

6. The method of claim 1, further comprising:
verifying, by the ambiguity detection training computer program, the ambiguity detection engine before it is deployed.

7. The method of claim 1, wherein the ambiguity detection engine is a plug-in to a computer program, and the computer program comprises a word processing program, a coding program, an email program, and/or a messaging program.

8. The method of claim 1, wherein the ambiguity detection engine is available via an Application Programming Interface.

9. The method of claim 1, wherein the ambiguity detection engine is configured to scan a code repository and/or a document repository.

10. The method of claim 1, further comprising:
receiving, by the ambiguity detection engine, feedback on the modification; and
re-training, by the ambiguity detection training computer program, the ambiguity detection engine based on the feedback.

11. The method of claim 1, wherein the training results in a plurality of mutually non-dominating models.

12. The method of claim 11, wherein the ambiguity detection engine is configured to select a detection level and to select one of the mutually non-dominating models based on the selection.

13. The method of claim 11, wherein each of the mutually non-dominating models has a different inclination to produce both true positive results and false positive results.

14. A system, comprising:
an electronic device executing an ambiguity detection training computer program;
a labeled dataset comprising data labeled by one or more neurodivergent individuals, wherein the data is labeled as clear or ambiguous; and
a user electronic device executing a computer program;
wherein:
the ambiguity detection training computer program receives the labeled dataset;
the ambiguity detection training computer program trains an ambiguity detection engine using the labeled dataset to predict ambiguities in new data;
the ambiguity detection training computer program deploys the ambiguity detection engine to the computer program;
the computer program receives the new data;
the computer program predicts, using the ambiguity detection engine, whether the new data is ambiguous; and
the computer program presents a modification to the new data based on the prediction.

15. The system of claim 14, wherein the ambiguity detection engine is deployed as a plug-in to a computer program, and the computer program comprises a word processing program, a coding program, an email program, and/or a messaging program.

16. The system of claim 14, wherein the ambiguity detection engine is deployed as an Application Programming Interface.

17. The system of claim 14, wherein the new data comprises data in a code repository and/or a document repository.

18. The system of claim 14, wherein the ambiguity detection engine receives feedback on the modification and re-trains the ambiguity detection engine based on the feedback.

19. The system of claim 14, wherein the training results in a plurality of mutually non-dominating models, wherein each of the mutually non-dominating models has a different inclination to produce both true positive results and false positive results.

20. The system of claim 19, wherein the ambiguity detection engine is configured to select a detection level and to select one of the mutually non-dominating models based on the selection.
